(19) United States
(12) Patent Application Publication
(10) Pub. No.: US 2011/0216096 A1
(43) Pub. Date: Sep. 8, 2011

(54) DISPLAY DEVICE

(75) Inventors: Takashi Sasaki, Kanagawa-ken (JP); Aira Hotta, Kanagawa-ken (JP); Akihisa Moriya, Kanagawa-ken (JP); Haruhiko Okumura, Kanagawa-ken (JP)

(73) Assignee: KABUSHIKI KAISHA TOSHIBA, Tokyo (JP)

(21) Appl. No.: 12/882,669

(22) Filed: Sep. 15, 2010

(30) Foreign Application Priority Data
Mar. 8, 2010 (JP) 2010-051111

(51) Int. Cl. G09G 5/10

(52) U.S. Cl. 345/690

(57) ABSTRACT

According to one embodiment, a display device includes a presentation unit, a setting unit and a control unit. The presentation unit is configured to produce a light flux including image information and to presenting the light flux to an eye of a human viewer. The setting unit is configured to receive luminance information to set a luminance of the light flux to be a first luminance, the first luminance being set by the human viewer. The control unit is configured to control the presentation unit to change the luminance of the light flux, the control unit controlling the presentation unit to make the luminance of the light flux to be a second luminance lower than the first luminance based on the luminance information received by the setting unit.

### CROSS-REFERENCE TO RELATED APPLICATIONS

This application is based upon and claims the benefit of priority from the prior Japanese Patent Application No. 2010-051111, filed on Mar. 8, 2010; the entire contents of which are incorporated herein by reference.

### FIELD

Embodiments described herein relate generally to a display device.

### BACKGROUND

Head-up displays (HUDs) allow the visual confirmation of operation information such as vehicle speed and travel direction and include HUDs that control the luminance of an image presented to a human viewer (for example, refer to JP-A 2008-1182 (Kokai)).

In such a HUD, the luminance of external light is measured. The luminance of the image presented to the human viewer is controlled based on the luminance of the measured external light.

However, at present, a specific method for controlling the luminance of the image has not been determined such that the human viewer can view the image comfortably.

### BRIEF DESCRIPTION OF THE DRAWINGS

FIG. 1 illustrates a display device according to a first embodiment;

FIG. 2 illustrates experimental results on evaluation of the comfort for luminances of the light flux;

FIG. 3 is a flowchart illustrating the control processing of the luminance of the display device;

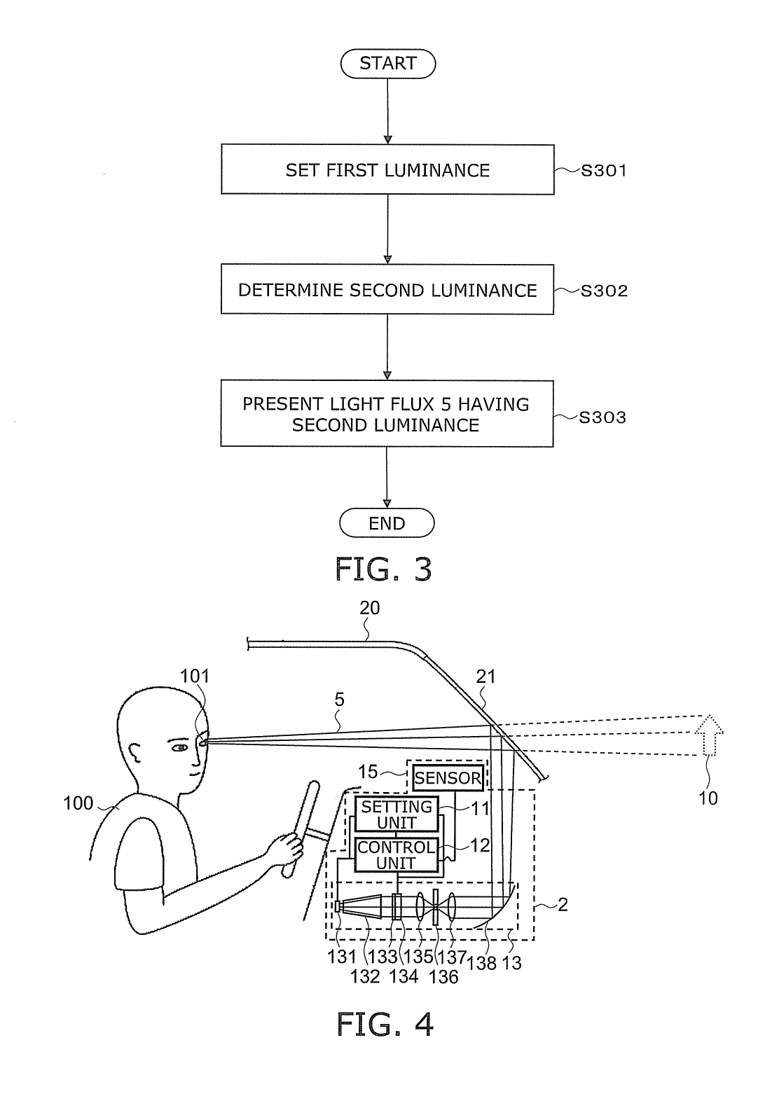

FIG. 2 illustrates a display device according to a second embodiment; and

FIG. 5 is a flowchart illustrating the control processing of the luminance of the display device.

### DETAILED DESCRIPTION

In general, according to one embodiment, a display device includes a presentation unit, a setting unit and a control unit. The presentation unit is configured to produce a light flux including image information and to presenting the light flux to an eye of a human viewer. The setting unit is configured to receive luminance information to set a luminance of the light flux to be a first luminance, the first luminance being set by the human viewer. The control unit is configured to control the presentation unit to change the luminance of the light flux, the control unit controlling the presentation unit to make the luminance of the light flux to be a second luminance lower than the first luminance based on the luminance information received by the setting unit.

Exemplary embodiments of the invention will now be described in detail with reference to the drawings.

In the specification and drawings of the application, components similar to those described in regard to a drawing thereinabove are marked with like reference numerals, and a detailed description is omitted as appropriate.

### First Embodiment

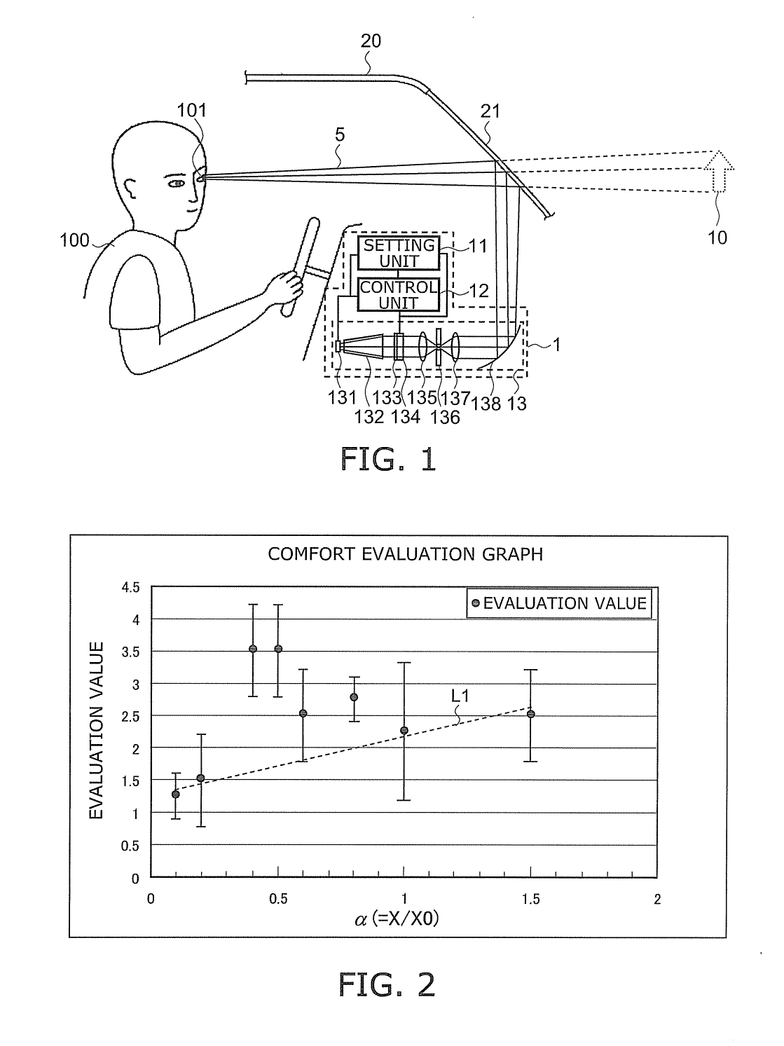

A display device 1 according to a first embodiment is an automotive head-up display that presents a light flux 5 having a controlled luminance to an eye 101 of a human viewer 100. FIG. 1 illustrates the display device 1. The display device 1 presents the light flux 5 to the eye 101 of the human viewer 100, where the light flux 5 includes an image of operation information such as navigation information, the speed of a vehicle 20, etc. (although one eye is illustrated in FIG. 1, both eyes may be used). Thereby, the human viewer 100 perceives the image as a virtual image 10 overlaid onto a landscape frontward of a windshield 21.

The display device 1 changes the luminance of the light flux 5 presented to the eye 101 of the human viewer 100 to a second luminance lower than a first luminance set beforehand by the human viewer 100. The display device 1 includes a setting unit 11, a control unit 12, and a presentation unit 13.

The presentation unit 13 produces the light flux 5 including the image information of the operation information. The presentation unit 13 irradiates the light flux 5 toward the windshield 21. A combiner may be provided on the windshield 21. The windshield 21 reflects the light flux 5 toward the eye 101 of the human viewer 100.

The presentation unit 13 includes a light source 131, a limiting unit 132, a diffuser unit 133, an image generating device 134, a first lens 135, an aperture 136, a second lens 137, and a reflecting plate 138.

The aperture 136 is positioned a distance of f1 from the first lens 135 and a distance of f2 from the second lens 137, where f1 is the focal distance of the first lens 135 and f2 is the focal distance of the second lens 137.

The propagation direction of the light flux 5 emitted from the light source 131 is limited by the limiting unit 132; and in such a state, the light flux 5 is incident on the image generating device 134 including the diffuser unit 133. The light flux 5 is diffused by the diffuser unit 133 and can be uniformly incident on the image generating device 134.

The light flux 5 passing through the image generating device 134 includes the image information and then passes through the first lens 135, the aperture 136, and the second lens 137. The light flux 5 is incident on the reflecting plate 138 in a state in which the divergence angle of the light flux 5 (the angle at which the light flux 5 diverges) is controlled.

Because the image generating device 134 is on the light source 131 side of the aperture 136, the transmittance of the light flux 5 passing through the image generating device 134 can be higher than that of the case where the aperture 136 is on the light source 131 side of the image generating device 134. Therefore, the power consumption of the light source 131 can be reduced.

The light source 131 may include a light emitting diode, a high pressure mercury lamp, a halogen lamp, a laser, etc. The limiting unit 132 may include a tapered light guide. The diffuser unit 133 may include a diffusion filter and a diffuser plate. The image generating device 134 may include a liquid crystal display, a digital mirror device, etc.

The setting unit 11 is operated by the human viewer 100. According to the operation, the light source 131, the image generating device 134, or both is controlled to change the luminance of the light flux 5. Namely, the human viewer 100 operates the setting unit 11 to set the luminance of the light flux 5 to a first luminance felt to be most comfortable.

After the human viewer 100 sets the first luminance, the control unit 12 controls the light source 131, the image generating device 134, or both to change the luminance of the light flux 5 to a second luminance which has a value lower than the first luminance.

The setting unit 11 and the control unit 12 are realized by a central processing unit (CPU) and memory used by the CPU. The memory may be capable of being manipulated by the human viewer 100.

Thus, the setting unit 11 receives luminance information to set the luminance of the light flux 5 to be a first luminance, which is set by the human viewer 100. The control unit 12 controls the presentation unit 13 to change the luminance of the light flux 5. The control unit 12 controls the presentation unit 13 to make the luminance of the light flux 5 to be a second luminance lower than the first luminance based on the luminance information received by the setting unit 11.

FIG. 2 is a graph of an evaluation by experiment of the comfort of the human viewer 100 experienced for luminances of the light flux 5. In this embodiment, an experiment was performed in which the light flux 5 of various luminances was presented to the human viewers 100 (the participants). The content of the experiment included mounting the display device 1 in an automobile driving simulator and presenting the light flux 5 to the participants. Prior to driving, each participant set a first luminance X0 to be the luminance at which the light flux 5 was felt to be the most comfortable (easily viewable). During the driving, a luminance X of the light flux 5 presented to the human viewer 100 was changed from the first luminance X0. An investigation was performed to evaluate whether or not the participant felt the light flux 5 to be easily viewable at each of the changed luminances X.

A ratio α of the luminance X to the first luminance X0 is plotted on the horizontal axis of FIG. 2. In other words, α=X/X0. The luminance X equals the first luminance X0 when α=1. The luminance X is less than the first luminance X0 when α<1. The luminance X is greater than the first luminance X0 when α>1. An evaluation value indicating the evaluation of whether or not the participant felt the light flux 5 to be comfortable is plotted on the vertical axis. A higher evaluation value indicates that the luminance X of the light flux 5 is comfortable for the participant. In this experiment, the light flux 5 presented to each of the participants had luminances X with α=0.1, α=0.2, α=0.4, α=0.5, α=0.6, α=0.8, α=1.0, and α=1.5.

As a result of the experiment, taking the evaluation value for α=1.0 to be a reference value of 2.25, the evaluation value was 1.25 for α=0.1, the evaluation value was 1.5 for α=0.2, the evaluation value was 3.5 for α=0.4, the evaluation value was 3.5 for α=0.5, the evaluation value was 2.5 for α=0.6, and the evaluation value was 2.5 for α=1.5.

In FIG. 2, the broken line L1 is a straight-line approximation through the evaluation values for α=0.1, α=0.2, α=1.0, and α=1.5. The broken line L1 is a straight line increasing monotonously with α. This is because the participant feels that the light flux 5 is easily viewable as the luminance X of the light flux 5 becomes brighter. However, the evaluation values for α=0.4, α=0.5, α=0.6, and α=0.8 are higher than the evaluation values of the straight line L1. This indicates that in the case where the display device 1 controls the luminance X of the image such that 0.4≦α≦0.8, the human viewer 100 can view the image when driving the vehicle 20 even more comfortably than with the first luminance set by the human viewer 100 prior to driving. In other words, the second luminance of this embodiment is a luminance that satisfies 0.4≦α≦0.8.

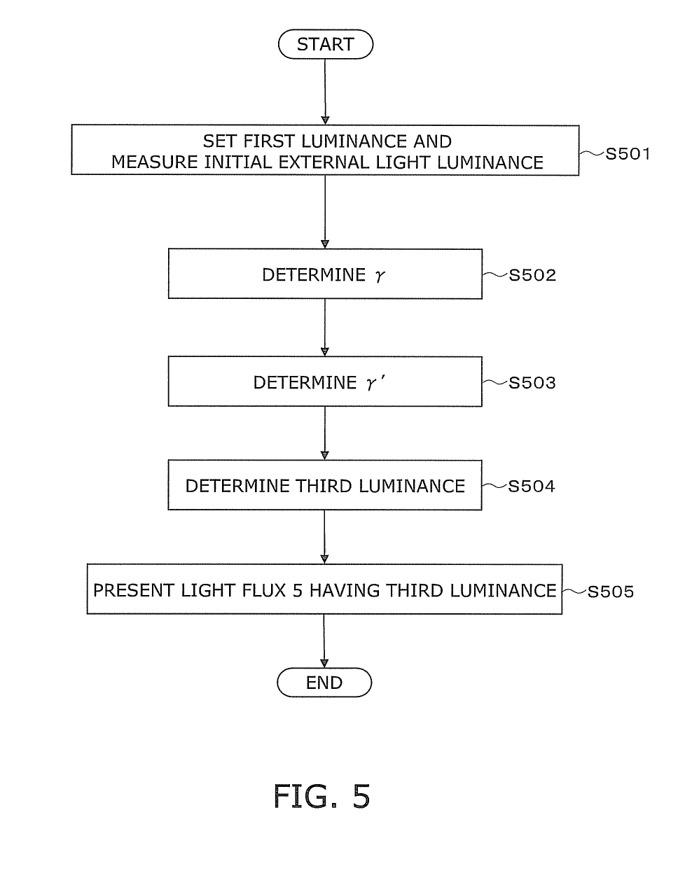

FIG. 3 is a flowchart illustrating the control processing of the luminance of the display device 1. In the setting unit 11, the first luminance is set by the human viewer 100 (S301). For example, prior to driving the vehicle 20, the human viewer 100 operates the setting unit 11 to set a first luminance that the human viewer 100 feels to be easily viewable. In other words, the human viewer 100 sets the first luminance while adjusting the luminance of the light flux 5 using the setting unit 11. For example, the setting unit 11 may include a dial capable of being rotated to adjust the luminance of the light flux 5. The setting unit 11 may be provided, for example, in the dashboard, front panel, car navigation system touch panel, etc., in the vehicle 20.

The control unit 12 determines the second luminance from the first luminance set using the setting unit 11 (S302). For example, in the case where the first luminance is set by the setting unit 11 to 600 nit, the control unit 12 determines the second luminance to be 300 nit which is 0.5 times 600 nit. The factor from 0.4 times to 0.8 times with which to multiply the first luminance to determine the second luminance may be determined beforehand in the design stage and may be determined arbitrarily by the human viewer 100. The control unit 12 may control the light source 131, the image generating device 134, or both to present the light flux 5 changed to the second luminance (S303). For example, the control unit 12 may change the luminance of the light flux 5 to the second luminance by controlling the amount of current supplied by a power source (not illustrated) to the light source 131.

According to this embodiment, the luminance of the image can be controlled such that the human viewer can view the image comfortably.

In the case where, for example, the human viewer 100 resets the first luminance while driving the vehicle 20, the control unit 12 may newly determine the second luminance and control the presentation unit 13. Further, the control unit 12 may pre-store multiple first luminances set by multiple human viewers 100. Thereby, it is unnecessary for the human viewer 100 to set the first luminance each time the display device 1 is used; and step S301 of FIG. 3 can be omitted.

### Second Embodiment

A display device 2 according to a second embodiment is different from the display device 1 according to the first embodiment in that the luminance of external light incident on the vehicle 20 (an external light luminance) is measured. Prior to the driving of the vehicle 20, the display device 2 solves for a first coefficient γ, which is the ratio of the first luminance set by the human viewer 100 to the external light luminance at that time, and determines a second coefficient γ′ from the first coefficient γ. The second coefficient γ′ satisfies Formula 1.

0.4γ<γ′<1.0γ (Formula 1)

During the driving of the vehicle 20, the display device 2 presents the light flux 5 having a third luminance to the human viewer 100, where the third luminance is the measured external light luminance multiplied by the second coefficient γ′.

FIG. 4 illustrates the display device 2. In addition to the configuration of the display device 1, the display device 2 further includes a sensor 15. The sensor 15 measures the external light luminance. The sensor 15 may be provided, for example, on the upper portion of the windshield 21, on the dashboard of the vehicle 20, on the hood, etc. The control unit 12 solves for the first coefficient γ from the first luminance set by the human viewer 100 and the external light luminance (the initial external light luminance) measured at that time. The control unit 12 determines the second coefficient γ′ for the first coefficient γ. The value in the range satisfying Formula 1 with which the second coefficient γ′ is determined may be determined beforehand in the design stage and may be determined arbitrarily by the human viewer 100. During the driving of the vehicle 20, the control unit 12 determines the third luminance by multiplying γ′ by the external light luminance measured by the sensor 15 and controls the light source 131, the image generating device 134, or both to change the luminance of the light flux 5 to the third luminance.

FIG. 5 is a flowchart illustrating the control processing of the luminance of the display device 2. In the setting unit 11, the first luminance is set by the human viewer 100 prior to driving the vehicle 20 (S501). The control unit 12 solves for the first coefficient γ from Formula 2 using the first luminance and the initial external light luminance measured by the sensor 15 when the first luminance is set (S502).

γ=(first luminance)/initial external light luminance (Formula 2)

For example, in the case where the first luminance is set to 600 nit and the external light luminance at that time (the initial external light luminance) is 400 nit, the control unit 12 determines the value of the first coefficient γ to be γ=600/400=1.5.

The control unit 12 determines the second coefficient γ′ from the first coefficient γ to satisfy Formula 1 (S503). For example, the control unit 12 determines the second coefficient γ′ to have a value of 0.75 which is 0.5 multiplied by the value of 1.5 of the first coefficient γ.

The control unit 12 determines the third luminance by multiplying the second coefficient γ′ by the current external light luminance measured by the sensor 15 (S504). For example, in the case where the second coefficient γ′ is 0.75 and the current external light luminance measured by the sensor 15 is 300 nit, the control unit 12 determines the third luminance to be 300×0.75=225 nit.

The control unit 12 controls the light source 131, the image generating device 134, or both to change the light flux 5 to the third luminance and present the light flux 5.

According to this embodiment, the luminance of the image can be controlled according to the luminance of the external light.

The embodiments can provide a display device capable of controlling the luminance of an image such that the human viewer can view the image comfortably.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. A display device, comprising:
a presentation unit configured to produce a light flux including image information and to presenting the light flux to an eye of a human viewer;
a setting unit configured to receive luminance information to set a luminance of the light flux to be a first luminance, the first luminance being set by the human viewer; and
a control unit configured to control the presentation unit to change the luminance of the light flux, the control unit controlling the presentation unit to make the luminance of the light flux to be a second luminance lower than the first luminance based on the luminance information received by the setting unit.

2. The device according to claim 1, wherein the second luminance is not less than 0.4 times the first luminance and not more than 0.8 times the first luminance.

3. The device according to claim 2, wherein
the presentation unit includes:
a light source to generate the light flux;
a limiting unit to limit a propagation direction of the light flux generated by the light source;
a diffuser unit to diffuse the light flux;
an image generating device to add the image information to the light flux diffused by the diffuser unit;
a first lens to concentrate the light flux passing through the image generating device;
an aperture to control a divergence angle of the light flux passing through the first lens;
a second lens to concentrate the light flux passing through the aperture; and
a reflecting plate to reflect the light flux toward the eye of the human viewer, and
the control unit changes the luminance of the light flux by controlling at least one selected from the light source and the image generating device.

4. The device according to claim 1, wherein
the first luminance is changed by the human viewer,
the control unit changes the second luminance based on the first luminance changed by the human viewer.

5. The device according to claim 1, wherein
at least the setting unit and the control unit stores information including the first luminance, and
the control unit determines the second luminance based on the stored first luminance.

6. A display device mounted in a vehicle, the device comprising:
a presentation unit to producing a light flux including image information and to presenting the light flux to a human viewer;
a sensor to measure a luminance of external light incident on the vehicle;
a setting unit configured to receive luminance information to set a luminance of the light flux to be a first luminance, the first luminance being set by the human viewer, the first luminance having a first coefficient being a ratio of the first luminance to the luminance of the external light during the first luminance being set; and
a control unit configured to control the presentation unit to change the luminance of the light flux to a third luminance based on the luminance information received by the setting unit and the luminance of the external light measured by the sensor, a third luminance having a second coefficient being a ratio of the third luminance to a currently measured luminance of the external light,
the control unit determining the second coefficient being lower than the first coefficient.

7. The device according to claim 6, wherein the second coefficient is not less than 0.4 times the first coefficient and not more than 0.8 times the first coefficient.

8. The device according to claim 6, wherein the second coefficient is greater than 0.4 times the first coefficient and less than 1.0 times the first coefficient.

9. The device according to claim 6, wherein the control unit determines the second coefficient when the vehicle is moving.

10. The device according to claim 6, wherein
the presentation unit includes:
a light source to generate the light flux;
a limiting unit to limit a propagation direction of the light flux generated by the light source;
a diffuser unit to diffuse the light flux;
an image generating device adding the image information to the light flux diffused by the diffuser unit;
a first lens concentrating the light flux passing through the image generating device;
an aperture controlling a divergence angle of the light flux passing through the first lens;
a second lens concentrating the light flux passing through the aperture; and
a reflecting plate reflecting the light flux toward the eye of the human viewer, and
the control unit changes the luminance of the light flux by controlling at least one selected from the light source and the image generating device.

11. The device according to claim 7, wherein
the presentation unit includes:
a light source to generate the light flux;
a limiting unit to limit a propagation direction of the light flux generated by the light source;
a diffuser unit to diffuse the light flux;
an image generating device adding the image information to the light flux diffused by the diffuser unit;
a first lens concentrating the light flux passing through the image generating device;
an aperture controlling a divergence angle of the light flux passing through the first lens;
a second lens concentrating the light flux passing through the aperture; and
a reflecting plate reflecting the light flux toward the eye of the human viewer, and
the control unit changes the luminance of the light flux by controlling at least one selected from the light source and the image generating device.

12. The device according to claim 6, wherein the reflecting plate reflects the light flux toward a windshield of the vehicle.

13. The device according to claim 6, wherein the reflecting plate reflects the light flux toward a combiner provided on a windshield of the vehicle.
